(19) United States
(12) Patent Application Publication
(10) Pub. No.: US 2005/0237255 A1
(43) Pub. Date: Oct. 27, 2005

(54) Small footprint dual band dipole antennas for wireless networking

(75) Inventors: Zhijun Zhang, San Diego, CA (US); Jean Christophe Langer, San Diego, CA (US)

Correspondence Address: GREER, BURNS & CRAIN, 300 S WACKER DR, 25TH FLOOR, CHICAGO, IL, 60606, US

(73) Assignee: Amphenol-T&M Antennas

(21) Appl. No.: 11/052,537

(22) Filed: Feb. 7, 2005

Related U.S. Application Data
(60) Provisional application No. 60/542,061, filed on Feb. 5, 2004.

(51) Int. Cl. H01Q 9/28

(52) U.S. Cl. 343/795; 343/700 MS; 343/702

(57) ABSTRACT

A small footprint dipole antenna of the invention for WLAN applications is designed for full natural resonance in a single band, e.g., the 2.4 GHz band, and uses a matching network to for artificial resonance at a second band, e.g., the 5 GHz band. The natural impedance of the dipole in second band is set in a range that produces an efficient antenna with substantial range in both of the first and second bands.

### CROSS REFERENCE TO RELATED APPLICATIONS

This application claims priority under 35 U.S.C. 119, to provisional application No. 60/542,061, filed on Feb. 5, 2004.

### FIELD OF THE INVENTION

A field of the invention is antennas. Another field of the invention is wireless networks, including, for example, local area networks that operate wirelessly. Another field of the invention is routers, such as those used to route wireless communications in a wireless network. Another field of the invention is inventory control and management systems, and in particular, systems that use a handheld reader, such as a bar code reader, that communicates wirelessly with a local or wide area network, for inventory control and management. Antennas of the invention have a small footprint, having lengths less than, for example 50 mm, widths of less than, for example 15 mm and thicknesses of less than, for example, one millimeter.

### BACKGROUND

Wireless local area networks (WLAN) are an important application of wireless communication. WLAN takes advantage of license-free frequency bands, industrial, scientific and medical (ISM) bands. WLAN uses both 2.412 GHz to 2.482 GHz (IEEE 802.11b and IEEE 802.11g) and 5.15 GHz to 5.825 GHz (IEEE 802.11a). To integrate both bands into one device, dual-band antenna design becomes critical if use of multiple antennas is to be avoided. Multiple antennas can make access points and routers less convenient to use, more expensive, and more prone to fault. However, a reliable multiple band WLAN requires an antenna that operates efficiently at multiple bands.

Various kinds of antennas, such as reduced size PIFA antennas [See, e.g., D. Nashaat, H. A. Elsadek and H. Ghali, “Dual-Band Reduced Size PIFA Antenna With U-slot for Bluetooth and WLAN Applications,” IEEE Antennas and Propagation Society International Symposium, 2003, USA, vol. 2, pp. 962-965], dual loop antennas [See, e.g., C. C. Lin, G. Y. Lee and K. L. Wong, “Surface-Mount Dual-Loop Antenna for 2.4/5 GHz WLAN Operation,” Electron. Lett., vol. 39, pp. 1302-1304, Sep. 4, 2003] and double T antennas [Y. L. Kuo and K. L. Wong, “Printed Double-T Monopole Antenna for 2.4/5.2 GHz Dual-Band WLAN Operations,” IEEE Transactions on antennas and propagation, vol. 51, n 9, pp. 2187-2192, September 2003] have been proposed to provide dual-band operation. Such antennas are suitable for low profile installations, but do not offer the good omni-directional coverage of dipole antennas.

Suh et al. reported a printed dipole antenna [Y. H. Suh and K. Chang, “Low cost microstrip-fed dual frequency printed dipole antenna for wireless communications,” Electron. Lett., vol. 36, pp. 1177-1179, Jul. 6, 2000.] for dual-band operation, in which two separate dipoles of different arm lengths are printed on both sides of a dielectric substrate and the longer and shorter dipoles are, respectively, designed to generate a resonant mode for operating in the 2.4 and 5.2 GHz bands. This kind of printed dipole antenna design, however, occupies a relatively large space and the bandwidth in 5 GHz is limited. The bandwidth of the antenna in 5 GHz band is 400 MHz and is not enough to cover whole 5 GHz band. Su et al reported a dual-band dipole [C. M. Su, H. T. Chen and K. L. Wong, “Printed Dual-Band Dipole Antenna with U-slotted Arms for 2.4/5.2 GHz WLAN Operation,” Electron. Lett., vol. 38, pp. 1308-1309, Oct. 24, 2002.], which obtained two resonances by cutting U-slots on the arms of dipole. The bandwidth in 5 GHz is 370 MHz. Chen reported a multi-band printed sleeve dipole antenna [T. L. Chen, “Multi-Band Printed Sleeve Dipole Antenna,” Electron. Lett., vol. 39, pp. 14-15, Jan. 9, 2003]. This antenna uses different strip pairs to compose various frequency resonances. This antenna provides enough bandwidth in both 2.4 GHz and 5 GHz band. However, the azimuth average gain in 2.4 GHz is low, around 0 dBi, which indicates a low efficiency.

Others have tried to get performance in two bands from a dipole. These approaches have either low efficiency [See, e.g., T. L. Chen, “Multi-Band Printed Sleeve Dipole Antenna,” Electron. Lett., Vol. 39, pp. 14-15, Jan. 9, 2003] or limited bandwidth in 5 GHz band [See, e.g., Y. H. Suh and K. Chang, “Low Cost Microstrip-Fed Dual Frequency Printed Dipole Antenna for Wireless Communications,” Electron. Lett., vol. 36, pp. 1177-1179, Jul. 6, 2000; and C. M. Su et al., “Printed Dual-Band Dipole Antenna With U-Slotted Arms for 2.4/5.2 GHz WLAN operation,” Electron. Lett., Vol. 38, pp. 1308-09, Oct. 24, 2002].

### SUMMARY OF THE INVENTION

A small footprint dipole antenna of the invention for WLAN applications is designed for full natural resonance in a single band, e.g., the 2.4 GHz band, and uses a matching network for artificial resonance at a second band, e.g., the 5 GHz band. The natural impedance of the dipole in second band is set in a range that produces an efficient antenna with substantial range in both of the first and second bands.

A dual band dipole antenna in embodiments of the invention makes use of a matching network that provides artificial resonance in one of two bands and occupies a small footprint. Many physical design geometries are possible to permit a wide range of mechanical implementations in different systems. The natural impedance of the dipole in the artificial resonance band, measured with the matching circuit removed, is set in an optimal range determined by the inventors for antenna performance during operation with the matching circuit. This impedance may be tuned by various characteristics of the dipole. In a preferred embodiment, a chamfer is provided in a particular length to achieve the desired impedance in the artificial resonance band. Other features, including slots, gaps, etc. may be controlled to achieve the impedance in the artificial resonance band.

An example embodiment prototype antenna exhibited a measured VSWR (voltage wave standing ratio) of 2:1 bandwidth in the 2.4 HGz band of 710 MHz. The measured VSWR 2:1 bandwidth in the 5 GHz band was wider than 1 GHz. The measured VSWR 3:1 bandwidth was more than 3.6 GHz, providing coverage from 2.32 GHz to more than 6 GHz. The dipole has 85%˜87% efficiency in 2.4 GHz band and 55˜64% efficiency in 5 GHz band. The range offered by the example embodiment (and by embodiments of the invention generally) provides a large manufacturing tolerance, making antennas of the invention practical for large scale fabrication.

### BRIEF DESCRIPTION OF THE DRAWINGS

FIG. 1 is a schematic diagram of an exemplary embodiment dual band dipole antenna of the invention;

FIG. 2 is a smith diagram illustrating the range of permissible and preferred natural impedances in the artificial band of a dipole antennas of the invention;

FIGS. 3A and 3B are schematic diagrams respectively illustrating exemplary embodiment perpendicular parallel feed dual band dipole antennas of the invention;

FIG. 4A is a side view image of a perpendicular feed dual band prototype antenna of the invention;

FIG. 4B is a top view image of the FIG. 4A prototype antenna of the invention;

FIG. 5A is a top view image of a parallel feed dual band prototype antenna of the invention;

FIG. 5B is a bottom view image of the FIG. 5A prototype antenna of the invention;

FIG. 6 is a schematic diagram of a dipole antenna used in simulations to determine the effect of dipole leg width variation on the natural impedance of a dipole antenna in an artificial second band;

FIG. 7A are plots of simulated VSWR for various width prototype antennas having the configuration of FIG. 8;

FIG. 7B is a Smith chart of the simulated impedance for the various width prototype antennas plotted in FIG. 7A;

FIG. 8 is a schematic diagram of a chamfered feed dipole antenna used in simulations;

FIG. 9A are plots of simulated VSWR for various width prototype antennas having the configuration of FIG. 8;

FIG. 9B is a Smith chart of the simulated impedance for the various width prototype antennas plotted in FIG. 9A;

FIG. 10A shows simulated VSWR vs. measured VSWR for another prototype antenna consistent with the FIG. 8 configuration;

FIG. 10B shows simulated impedance vs. measured impedance for the prototype antenna of FIG. 10A;

FIG. 11A shows a measurement convention used to measure radiation patterns of the prototype antenna characterized in FIGS. 10A and 10B, FIGS. 11B-11D respectively illustrate measured patterns at 2.45 GHz in the x-y, x-z, and y-z planes, and FIGS. 11E-G respectively illustrate measured patterns at 5.5 GHz in the x-y, x-z, and y-z planes;

FIG. 12 shows simulated current distribution for the prototype antenna characterized in FIGS. 10A-10B and 11B-11G in both the 2.4 and 5 GHz bands;

FIG. 13 illustrates an exemplary wireless local area network (WLAN) of the invention; and

FIG. 14 illustrates and exemplary embodiment antenna of the invention used in the WLAN of FIG. 13.

### DETAILED DESCRIPTION OF THE PREFERRED EMBODIMENTS

A preferred antenna package is a PCB antenna package on or within a plastic substrate, for example an epoxy and glass fiber substrate, e.g., an FR4 substrate that may be very thin, for example less than 1 mm. Generally, antennas of the invention have small footprints, e.g. lengths of less than 100 mm, and preferably less than 50 mm, and widths of less than 40 mm and preferably less than 15 mm. Thicknesses may be very thin, for example preferably less than 0.5 mm and generally less than one millimeter or a few millimeters. Preferred embodiments include particular dimensions and materials, which will be described below, but the invention is not so limited in its broader aspects. For example, embodiments of the invention include substrates with selected and optimized electrical properties and thicknesses for different bands and performance, and, similarly, different conductors can be used without modifying the design methodology that will be presented below.

An example system of the invention includes one or more compact devices. The compact devices communicate wirelessly within a wireless network. The wireless network includes for example, a router that may receive wireless communications from one or more devices. The network may also include access points at various locations, for example, to extend the range of the network. The latter approach is advantageous, for example, for low power short range communications. The router and/or one or more access points communicate with portable devices through a dual band dipole antenna, which has additional resonance added through a matching network. The single dual band dipole antenna exhibits two strong bands provided for communication.

Some preferred embodiments will now be discussed with respect to the drawings. The drawings may not be to scale, and features may be exaggerated for the purposes of illustration. Schematic representations may be presented, and will be fully understood by artisans, especially in view of the above and following description.

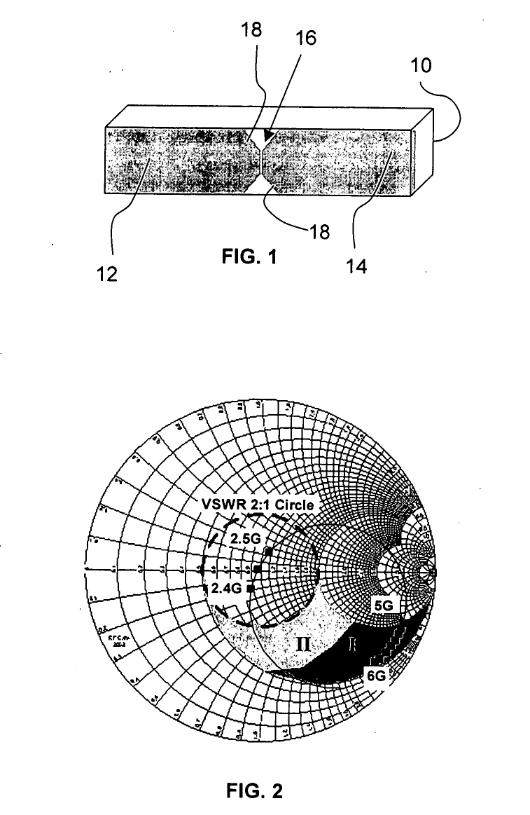

FIG. 1 shows an exemplary embodiment antenna of the invention. The antenna includes a dielectric substrate 10. The substrate 10 supports, i.e. holds or contains two separate dipole radiator legs 12, 14 in the same plane. While embodiments to be shown in the drawings show dipole legs held on dielectric surfaces, dipole legs may also be packaged (contained) in dielectric, as artisans will appreciate. The dipole radiator legs 12, 14 are thin conductive films, and are separated by a gap 16 between the dipole radiator legs. The feed of the dipole antenna will be at the gap 16, but is omitted from the illustration in FIG. 1. Additionally, a matching network will be connected to the dipole radiator legs 12 and 14, but is omitted from the illustration in FIG. 1 so that the physical features of the antenna may be discussed with respect to design principles related to the tuning of the antenna. In the example embodiment of FIG. 1, each of the dipole radiators defines a chamfer 18 at its central end.

A preferred embodiment antenna of FIG. 1 can be a flexible conductive board (commonly called ‘flex’) of conductive material that forms the dipole legs 12 and 14. The flex circuit board may also wrap around the substrate 10, such as over the top in the view of FIG. 1. The substrate 10, hollow or full, can be made of any material chosen for its mechanical and electrical properties, and can be made of any shape (e.g. rectangular, circular cuts). The flex commonly has adhesive on its back to stick to the substrate support. Depending on the space available for the antenna, the flex can be positioned flat on a planar substrate, or wrapped around a 3 dimensional substrate. Copper traces on the flex may not use the whole available space on the substrate 10.

Other physical components may also be used to construct an antenna in accordance with FIG. 1. For example, preferred embodiment antennas can have different parts soldered or electrically connected to each other. For example, the substrate 10 of the antenna can be a PCB on which two metal parts are soldered each side to form the legs 12, 14 of the dipole. Other embodiments of the invention include radiator (conductive) elements of different shapes, rectangular, cylindrical, hollow or full, and may include slots and other features, for example to tune particular bands. In other embodiments, the dipole radiator legs, as well as matching circuit elements and a feed to the dipole legs, are formed by microcircuit fabrication and patterning.

Antennas of the invention perform over two bands, each with a substantial range. A first band will be referred to as the natural resonance band. This band is the band in which the antenna radiates without any matching network. A second band will be referred to as the artificial band. This band is achieved with a matching network. Natural resonance means that the antenna radiates by itself without any matching network. The naturally occurring real resonance of an antenna is therefore solely a function of the antenna's physical design. Artificial is used herein to describe resonance that is helped by the matching network. The chamfers in the FIG. 1 embodiment are dimensioned relative to the dipole legs 12, 14 to give the antenna natural impedance in the artificial band that, as recognized by the present invention, provides excellent performance when the antenna is operated with the matching circuit in the artificial band.

An exemplary embodiment antenna is configured to naturally have real resonance in a first band, e.g., the IEEE 802.11b and 802.11g (2.4 GHz) band, and including a matching network to achieve artificial resonance at a second band, e.g., the 802.11a (5 GHz) band. A simple matching network is possible. By correctly designing the dipole, the matching network can be simplified to only one series inductor. A matching network may include series inductance, series capacitance, shunt inductance, or shunt capacitance. An inductor might also be replaced by a short wire acting as an inductor at 5 GHz. If such an approach is used, no passive circuit component is necessary to obtain a dual band antenna. The wire to act as an inductor may be a simple conductive trace on the substrate that connects to the dipole radiator legs.

Preferred embodiments seek to optimize the antenna performance and simplify the matching network required for the addition of a second band. To optimize the performance, the antenna impedance should be designed to be as close to source impedance (typically 50 Ω) as possible. To simplify the matching network, complex impedance should be selected with reference to the antenna's impedance to create a matching network that is as simple as possible, and in many cases as simple as only one component.

As an illustrative example, FIG. 2 shows the natural impedance of an exemplary embodiment thin trace printed dipole. The dipole is designed for 2.4˜2.5 GHz. The dash line circle on the middle of Smith Chart is the VSWR 2:1 circle. Any impedance inside this circle provides a lower VSWR value than 2:1, which is normally the specification of standards relating to personal wireless communication. The dipole shown in FIG. 1 is well matching in 2.4˜2.5 GHz, and the simulated VSWR is less than 1.3:1 throughout 2.4˜2.5 GHz. If a single-component matching network needs to match the 5 GHz band and keep the response in the 2.4 GHz band, there are only two choices, series inductor or shunt capacitor. A prototype embodiment exhibits some capacitance in the 5 GHz band, thus only a series inductor need be used as the matching network.

There are two shaded areas, Area I and Area II, in FIG. 2. When the natural antenna impedance of 5 GHz band falls into any of these two areas, the antenna can be matched to get artificial resonance by only one series inductor. Area II is the preferred area. Although a matching circuit can be used to get good VSWR value when the natural impedance falls inside Area I, the performance of this antenna will be very poor. As a rule of thumb, an acceptable performance of an antenna can be obtained through a matching network when the VSWR without matching network is less than 5:1, however, preferred embodiments of the invention provide antennas where the natural impedance in the 5 GHz falls within the VSWR 3:1 circle. Area II is therefore preferably bounded by the VSWR 3:1 circle and the constant resistance arcs that define the VSWR 2:1 circle. To be matched by a single serial-inductor and get good performance, the impedance of any antenna should fall into the Area II.

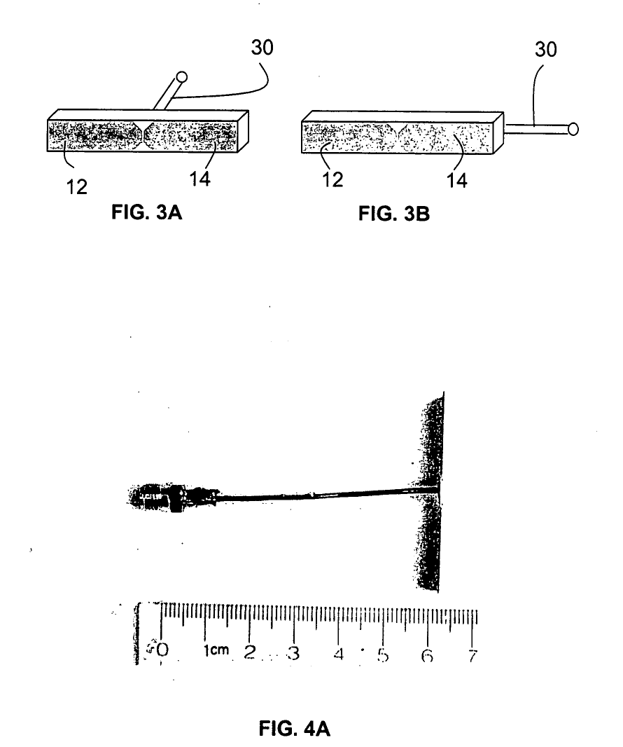

Different feed arrangements may be used to feed dipole antennas of the invention. Two exemplary feed arrangements are illustrated in FIGS. 3A and 3B. FIG. 3A illustrates a perpendicular plane feed arrangement, in which a coaxial cable 30 feeds dipole legs 12 and 14 at the center near the gap 16. Different cables and connector types may be used, and different feeding techniques can be used. In FIG. 3A the coaxial feed cable 30 is perpendicular to the plane of the dipole legs 12, 14. In FIG. 3B, the coaxial feed cable 30 has most of its length parallel to the plane of the dipole legs 12, 14, on an opposite side of the substrate 10.

In another embodiment, a preferred antenna is fed through a transmission line printed on a printed circuit board (PCB), for example a coplanar line or microstrip line. In an embodiment of the invention, a transmission line is on the same side of the PCB as the dipole legs. In another embodiment of the invention, a transmission line is on the other side of a PCB as the dipole legs.

Prototype dual band dipole antennas will now be discussed, along with principles for their design that artisans will appreciate provide for generalization of the dual band dipole with induced artificial resonance in one band. Artisans will appreciate many broader aspects of the invention from the following description. The following discussion includes prototypes that are consistent with the preferred embodiments along with design principles that may be applied by artisans to produce additional dual band dipole antennas with artificial resonance.

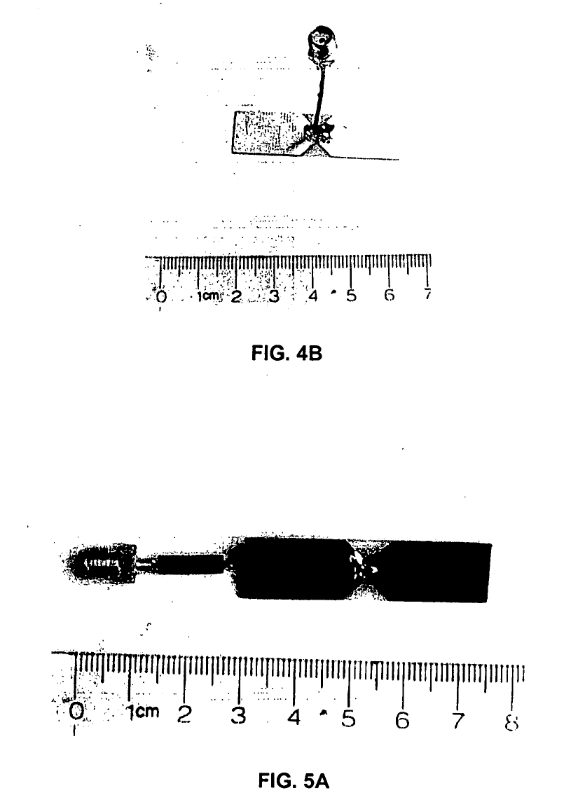

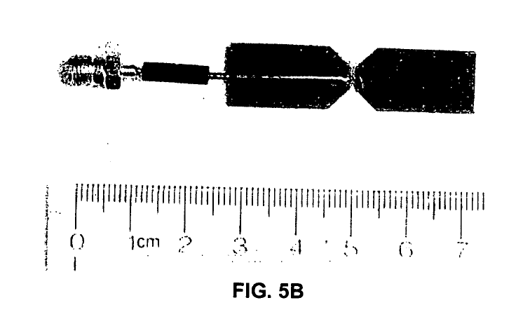

FIGS. 4A and 4B illustrate a prototype perpendicular feed antenna of the invention. FIGS. 5A and 5B illustrate a prototype parallel feed antenna of the invention. A prototype in accordance with FIGS. 4A and 4B was a dipole made of FR4 board (12 mm*45 mm*0.45 mm). The measured VSWR 2:1 bandwidth in the 2.4 HGz band is 710 MHz. The VSWR 2:1 bandwidth in the 5 GHz band is wider than 1 GHz. The VSWR 3:1 bandwidth is more than 3.6 GHz and it covers from 2.32 GHz to above 6 GHz. The dipole has 85%˜87% efficiency in 2.4 GHz band and 55˜64% efficiency in 5 GHz band. The range offered by the invention provides a large manufacturing tolerance. Antenna bandwidth should be designed even wider than the working bandwidth to guarantee a good yield, thus 5 GHz to 6 GHz is used in the prototypes as the 5 GHz band, instead of 5.15 GHz to 5.825 GHz.

To widen the bandwidth of a single band dipole, the diameter of dipole arms may be increased, as with traditional dipole design theory. This technique may be used with the invention to increase the width of printed dipole, not for increasing the bandwidth of 2.4 GHz band (real resonance band), but instead to increase the radiation impedance of the (artificially induced) 5 GHz band.

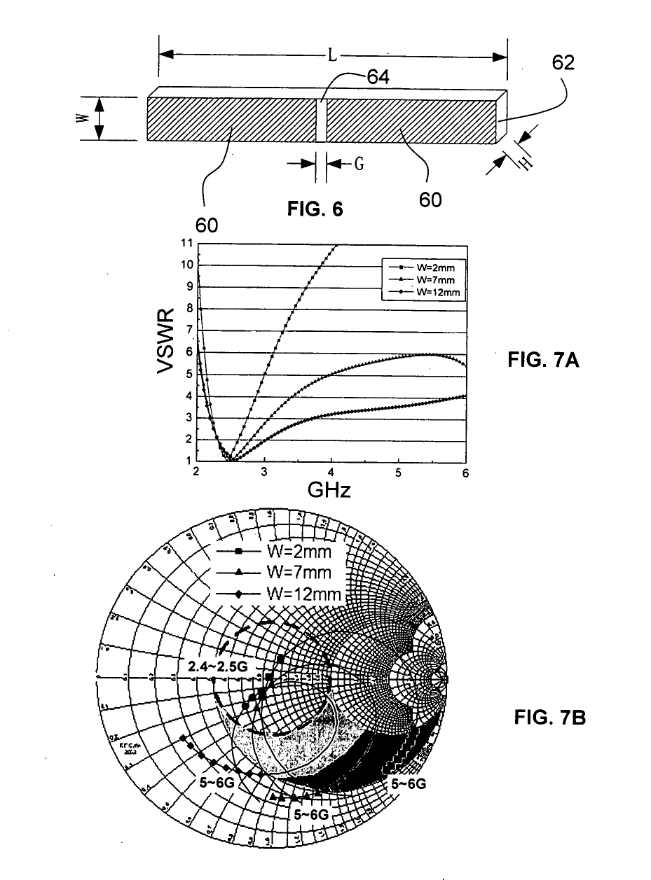

FIG. 6 is a schematic diagram of a printed dipole used in simulations. The dipole legs 60 were printed on a FR4 (εr=4.5) substrate 62. The thickness of substrate 62 is H, the length of the substrate 62 is L, and the width of the substrate 62 is W. The dipole legs 60 were copper traces on the top of substrate 62. A gap 64 between the two legs has a width of G. During testing, the printed dipole was fed at the middle of the gap 64.

HFSS® was used on all simulations discussed herein. FIG. 7A shows simulated VSWR and impedance of different width dipoles having the general configuration illustrated in FIG. 6. For all simulations in FIG. 7A, the length L=45 mm, the gap G=1 mm, and the thickness H=0.45 mm. The width of dipoles changes from 2 mm to 12 mm. FIG.7A shows that with increasing width, the bandwidth around 2.4˜2.5 GHz increases. More importantly, the VSWR in 5—6 GHz band decreases. When the width of a dipole is 7 mm the VSWR is around 6:1 in 5 GHz band. When the width increases to 12 mm, the VSWR improves to around 4:1, which will provide a good performing antenna in the 5 GHz band with a matching network.

FIG. 7B shows the simulated impedance of FIG. 7A on a Smith chart. With the increase of dipole width, the VSWR is improved, but the dipole impedance in 5 GHz band moves out of the range where a single series inductor can match the antenna. Some modification on the antenna has to be made to shift the 5 GHz band impedance back to shaded area and at the same time keep the antenna response in 2.4 GHz band.

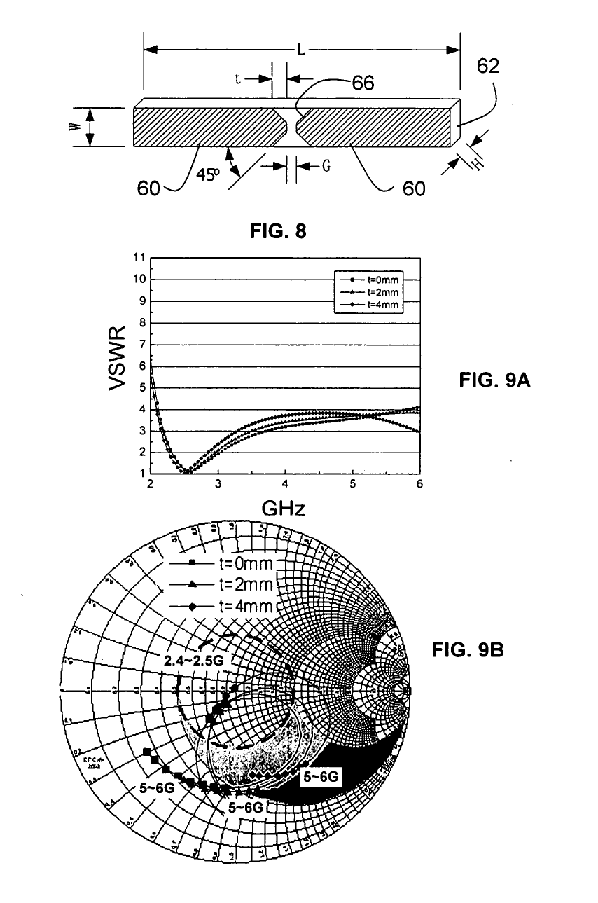

There are many ways to shift 5 GHz band impedance on smith chart, such as use of slots use of variable width dipole legs. A preferred technique is to chamfer the feed point. FIG. 8 illustrates a chamfered feed point dipole. This was used in prototypes. The FIG. 8 antenna is similar to the FIG. 6 antenna, but additional includes chamfers 66 at the feed point of the dipole legs 60. The chamfers are over a chamfered length t, and may be formed at various angles. A 45 degree angle was used in all prototypes, but different chamfered angles can also be used to tune the antenna. The chamfered length t can be a value between 0 to W/2. If t equals 0, the dipole legs 60 are not chamfered.

FIG. 9A shows simulated VSWR and impedance of different chamfered length dipoles having the chamfered configuration of FIG. 8. For all simulations in FIG. 9A, the length of dipole legs L=45 mm, the gap G=1 mm, the thickness H=0.45 mm, and the width W=12 mm. The chamfered length of dipole legs changes from 0 mm to 4 mm. FIG. 9A shows with the chamfered length increasing, the bandwidth around 2.4˜2.5 GHz decreases slightly, and the VSWR in 5˜6 GHz band improves slightly. Overall, the antenna response does not vary too much. The VSWR 2:1 bandwidth of 2.4 GHz band is at least six times wider than the required working bandwidth.

FIG. 9B shows the antenna impedance on Smith chart. It can be seen that with the chamfered length increase the 5 GHz band impedance moves in the anti-clockwise direction. When t equals 4 mm, the 5 GHz band impedance falls into the light shaded area, where the antenna can be matched by a single series inductor and get good performance. Thus, 4 mm defines the chamfered length of a preferred embodiment antenna. With the 4 mm dimension, a 1.5 nH series inductor may be used as the matching component.

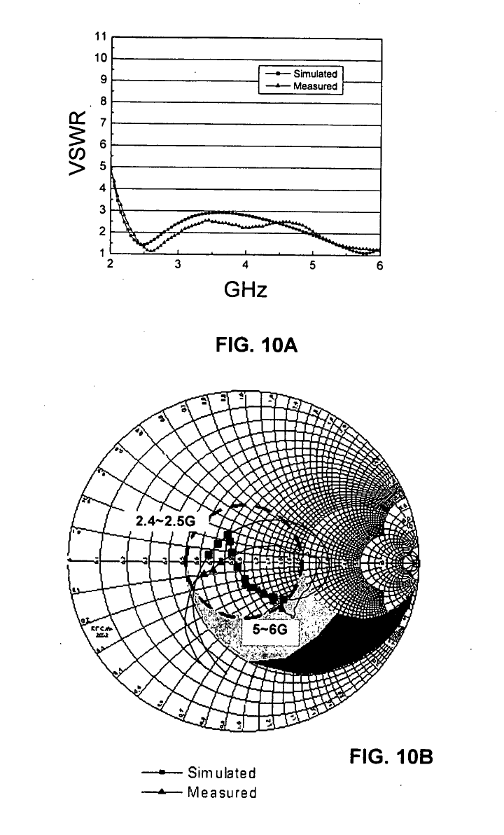

Another prototype antenna of the invention consistent with the configuration of FIG. 8 was constructed on an FR4 board and tested. The thickness of FR4 board was H=0.45 mm. The length L of the dipole was 45 mm, the gap G was 1 mm, the width W was 12 mm and the chamfered length t was 4 mm. A Johanson Technology 1.5 nH inductor was serial connected between the center wire of coaxial cable used to feed the antenna and one leg of the dipole as a matching network. The outer conductor of the coaxial cable was connected to the other leg of the dipole. The self-resonant frequency of the 1.5 nH inductor was higher than 15 GHz, which is much higher than the highest operating frequency of the dipole. The cable feed was a perpendicular feed as shown in FIGS. 4A and 4B. FIG. 10A shows the simulated VSWR vs. measured VSWR for the prototype antenna. The VSWR 2:1 bandwidth at 2.4 GHz band is 710 MHz, from 2.32 GHz 3.03 GHz. The VSWR 2:1 bandwidth at 5 GHz band starts from 5 GHz and is larger than 1 GHz. Due to the frequency limitation of the network analyzer being 6 GHz, the upper boundary of working frequency band could not be measured. If VSWR 3:1 is used to calculate the bandwidth, the bandwidth of prototype antenna is more than 3.6 GHz and it covers from 2.32 GHz to above 6 GHz. The VSWR 2:1 bandwidth in both 5 GHz and 2.4 GHz band exceeds the requirement of any dual band WLAN application. FIG. 10B shows the simulated impedance vs. measured impedance on a Smith chart. They agree well, as they do in FIG. 10A.

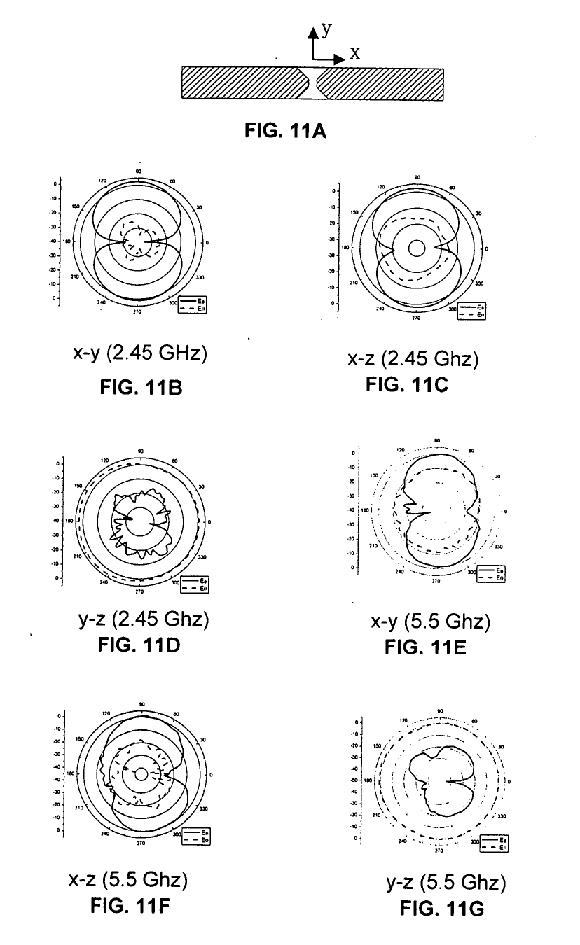

FIGS. 11B-11G show measured patterns for the antenna characterized in FIGS. 10A and 10B, and FIG. 11A shows the measurement convention. FIGS. 11B-D respectively illustrate measured patterns at 2.45 GHz in the x-y, x-z, and y-z planes. FIGS. 11E-G respectively illustrate measured patterns at 5.5 GHz in the x-y, x-z, and y-z planes. A Satimo® 3D near field chamber was used to measure the radiation pattern. Ferrite beads were used to cover part of test cable that is close to antenna, and the feed was perpendicular. The length of the ferrite bead covered part was approximately 400 mm. The ferrite beads were used to suppress the surface current introduced by radiation from the antenna under test. At the 2.4 GHz band, the antenna pattern is close to an ideal dipole pattern. At 5.5 GHz band, surface current was still excited even with the presence of ferrite beads. The surface current also radiates, which distorted the measured patterns. The azimuth (y-z plane) average gain is round 1.3 to 1.5 dBi in 2.4 GHz band and −0.2 to 0.3 dBi in 5 GHz band.

A Satimo® 3D chamber can also provide the efficiency of a measured antenna. The efficiency is defined as the ratio of radiated power vs. total available power from power source. Thus, the efficiency value includes all impacts from mismatch loss, dielectric loss, conductor loss and matching component loss. The measured efficiency of the prototype dipole in the 2.4 GHz band ranged from 85% to 87%. The measured efficiency of the prototype dipole in the 5 GHz band ranged from 55% to 64%.

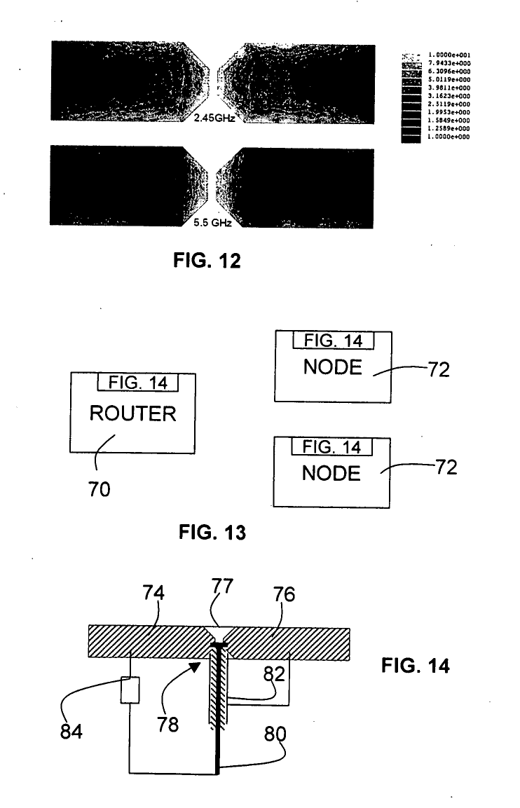

FIG. 12 shows simulated current distribution for the prototype antenna characterized in FIGS. 10A-10B and 11B-11G in both the 2.4 and 5 GHz bands. In the 2.4 GHz band, the current distribution is similar to a traditional single band dipole antenna. The measured antenna patterns shown in FIGS. 11B-D also provide a similar observation. In the 5 GHz band, the current concentrates on the edge that is close to the feed point, but there is still substantial residual current on the far edge. In the 5 GHz band, the radiation pattern has narrower beam width in the elevation plane (x-y and x-z plane) than a traditional dipole antenna, but the pattern is suitable for practical applications, and demonstrates both wide band (with a VSWR of 3:1) and dual substantial band (with a VSWR of 2:1) performance in a single dipole. The principles discussed herein will permit artisans to achieve specific tunings to particular bands, and the prototypes provide preferred antennas for WLAN bands, particularly the 2.4 and 5 GHz bands. The principles discussed will also permit optimizations in the 2.4 and 5 GHz bands, and many physical packages and fabrication techniques will be apparent to artisans.

A particular preferred embodiment includes a dual band dipole antenna for a wireless local area network (WLAN), in addition to a wireless area network having at least one router and/or at least one wireless access point including a dual band dipole antenna. An example WLAN is shown in FIG. 13 and each of a router 70 and nodes 72 include a dual band dipole illustrated schematically in FIG. 14, and dimensioned and tuned, for example in accordance with FIG. 8 and/or the prototypes discussed above. In preferred embodiments, the dual band dipole antenna is designed to have a first natural resonance in the 2.4 GHz band. A second resonance band is artificially produced by a matching network to produce resonance in another band, e.g. the 5 GHz band. Referring to FIG. 14, the antenna in each of the routers and nodes includes dipole legs 74, 76 held on a dielectric substrate 77. A feed 78 is to the center of the dipole legs 74, 76. The feed 78 is a coax feed, with a conductor 80 that propagates the radiation signals between the antenna and RF circuits of a device connected to the antenna. The feed 78 also has second conductor 82 that is insulated from the first conductor and is typically connected to the ground of the RF circuit of the device connected to the antenna. An inductor 84 provides a matching network. The inductor is connected between the leg 74 and the conductor 80, and the second conductor 82 is connected to the other leg 76.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A small footprint antenna for wireless networking, the antenna covering first and second WLAN (wireless local area network) frequency bands, the antenna comprising:
a thin dielectric substrate;
first and second dipole legs supported by said dielectric substrate;
a gap between said first and second dipole legs; and
a feed point to said first and second dipole legs at said gap;
said first and second dipole legs being dimensioned to have full natural resonance in the first WLAN band and artificial resonance in the second WLAN band, the natural impedance of the antenna in the second WLAN band having a VSWR of 5:1 or less.

2. The antenna of claim 1, further comprising a feed connected to said feed point.

3. The antenna claim 2, wherein said feed is in a plane perpendicular to said dipole legs.

4. The antenna of claim 3, wherein said feed is in a plane parallel to said dipole legs.

5. The antenna of claim 1, wherein said first and second dipole legs are formed on a surface of the substrate.

6. The antenna of claim 5, wherein said first and second dipole legs wrap around said substrate.

7. The antenna of claim 1, wherein said first and second dipole legs being dimensioned to have full natural resonance in the first WLAN band with a VSWR of 2:1 or less and artificial resonance in the second WLAN band, the natural impedance of the antenna in the second WLAN band having a VSWR of 3:1 or less.

8. The antenna of claim 1, wherein the first and second WLAN bands include the IEEE 802.11b and IEEE 802.11g band the IEEE 802.11a band.

9. The antenna of claim 8, comprising a chamfer in each of said first and second dipole legs at the feed point.

10. The antenna of claim 9, wherein said first and second dipole legs each have a length of 75 mm or less, widths 40 mm or less and the substrate has a thickness of less than a few millimeters.

11. The antenna of claim 10, wherein said first and second dipole legs each have a length of 45 mm and a width of 12 mm, and the substrate has a thickness of approximately 0.45 mm, and the gap between the first and second dipole legs is 1 mm.

12. The antenna of claim 11, wherein the length of said chamfer in each of said first and second dipole legs is less than 4 mm.

13. The antenna of claim 11, wherein the length of said chamfer is less than or equal to ½ of the length of each of said first and second dipole legs.

14. The antenna of claim 1, wherein said substrate comprises an FR4 substrate and said first and second dipole legs comprise conductors printed on said FR4 substrate.

15. A small footprint antenna for wireless networking, the antenna covering first and second WLAN frequency bands, the antenna comprising:
dipole leg means for naturally resonating in the first WLAN band and artificially resonating, when connected to a matching circuit, in the second WLAN band;
support means for supporting said dipole leg means; and
tuning means, with said dipole leg means, for tuning the antenna to have full natural resonance in the first WLAN band and artificial resonance in the second WLAN band, the natural impedance of the antenna in the second WLAN band having a VSWR of 3:1 or less.

16. The antenna of claim 15, where said tuning leg means tune the antenna to have a natural impedance VSWR of 2:1 or less in the first WLAN band.

17. A WLAN router comprising an antenna according to claim 15.

18. A WLAN access point comprising an antenna according to claim 15.

19. A small footprint antenna for wireless networking, the antenna covering first and second WLAN (wireless local area network) frequency bands, the antenna comprising:
a thin dielectric substrate;
first and second dipole legs supported by said dielectric substrate;
a gap between said first and second dipole legs; and
a feed point to said first and second dipole legs at said gap;
said first and second dipole legs being dimensioned to have a VSWR 3:1 bandwidth of more than 3.6 GHz and covering a band from 2.32 GHz to above 6 GHz.

20. A small footprint antenna for wireless networking, the antenna covering first and second WLAN (wireless local area network) frequency bands, the antenna comprising:
a thin dielectric substrate;
first and second dipole legs supported by said dielectric substrate;
a gap between said first and second dipole legs; and
a feed point to said first and second dipole legs at said gap;
said first and second dipole legs being dimensioned to provide a natural impedance in the first WLAN frequency band falling within the VSWR 2:1 circle on a Smith chart and a natural impedance in the second WLAN frequency band falling within an area defined by constant resistance lines on the Smith chart that bound the VSWR 2:1 circle and a VSWR 3:1 circle on the Smith chart.
